(19) United States
(12) Patent Application Publication
(10) Pub. No.: US 2025/0265395 A1
(43) Pub. Date: Aug. 21, 2025

(54) SYSTEM AND METHOD FOR RESOURCE SHARING IN AN ELECTRONIC DESIGN AUTOMATION CLOUD ARCHITECTURE

(71) Applicant: Microchip Technology Incorporated, Chandler, AZ (US)

(72) Inventor: Florinel lordache, Bucharest (RO)

(73) Assignee: Microchip Technology Incorporated, Chandler, AZ (US)

(21) Appl. No.: 19/057,261

(22) Filed: Feb. 19, 2025

Related U.S. Application Data
(60) Provisional application No. 63/555,225, filed on Feb. 19, 2024.

(51) Int. Cl. G06F 30/27; G06F 30/392

(52) U.S. Cl. CPC G06F 30/27; G06F 30/392

(57) ABSTRACT

A cloud-based computer system for electronic design automation (EDA) is provided. The cloud-based computer system may include one or more processors, and a memory storing instructions executable by the one or more processors. The instructions, when executed, may cause the system to provide a cloud EDA artificial intelligence (AI) expert module to learn and evolve in an electronic designing field using a new set of electronic design methodologies data, store a new set of refined electronic design methodologies data, and update an AI agent associated with an EDA tool executed on a user device. The AI agent may receive a set of EDA-related knowledge data associated with a user activity on the EDA tool, transmit the received data to a cloud EDA AI expert module for processing, and receive the new set of refined electronic design methodologies data to enhance user assistance in the electronic design process.

### CROSS REFERENCE TO RELATED APPLICATIONS

The present application claims priority to U.S. Provisional Patent Application No. 63/555,225, entitled: System and Method for Resource Sharing in an Electronic Design Automation Cloud Architecture, filed on Feb. 19, 2024, the contents of which are hereby incorporated by reference in their entirety.

### TECHNICAL FIELD

The present disclosure relates generally to electronic design automation (EDA) systems, and more specifically to a system and method for resource sharing in an EDA cloud architecture that incorporates an artificial intelligence (AI) expert system.

### SUMMARY

According to an aspect of one or more examples, there is provided a cloud-based computer system for electronic design automation (EDA). The cloud-based computer system may include one or more processors, and a memory storing instructions executable by the one or more processors. The instructions, when executed, may cause the system to provide a cloud EDA artificial intelligence (AI) expert module to learn and evolve in an electronic designing field using a new set of electronic design methodologies data, store, in a cloud EDA knowledge base, a new set of refined electronic design methodologies data generated by the cloud EDA AI expert module, and update an AI agent associated with an EDA tool executed on a user device. The AI agent may receive, from the user device, a set of EDA-related knowledge data associated with a user activity on the EDA tool, transmit the received data to the cloud EDA AI expert module for processing, and receive, from the cloud EDA AI expert module, the new set of refined electronic design methodologies data to enhance user assistance in the electronic design process.

The cloud EDA AI expert module may include a deep neural network architecture that uses one or more deep learning algorithms to learn and evolve in the electronic designing field. The new set of refined electronic design methodologies data may include multiple schematics, chip designs, and printed circuit board (PCB) layout techniques. The AI agent may include a neural network that applies one or more reinforcement learning algorithms to assist the user in the designing process. The AI agent may detect electrical issues during the designing process. The AI agent may provide suggestions to the user to resolve the detected electrical issues. The AI agent may offer suggestions to the user for electrical improvements during the designing process. The EDA tool may be web-based. The EDA tool may be desktop-based.

According to an aspect of one or more examples, there is provided a computer-implemented method for resource sharing in an electronic design automation (EDA) cloud architecture. The method may include receiving, at a cloud-based EDA artificial intelligence (AI) expert module, EDA-related knowledge data from a user device, the knowledge data being associated with user activity on an EDA tool, processing, at the cloud EDA AI expert module, the received knowledge data to generate a new set of methodologies data, storing, in a cloud EDA knowledge base, a new set of refined electronic design methodologies data, wherein the refined data is generated based on aggregated updates and analysis results from the cloud EDA AI expert module, transmitting the refined electronic design methodologies data to an AI agent associated with the EDA tool on the user device, and providing, by the AI agent, enhanced design task assistance to the user based on the refined electronic design methodologies data received from the cloud EDA AI expert module.

The cloud EDA AI expert module may include a deep neural network architecture applying deep learning algorithms. The refined data may include schematics, chip designs, and printed circuit board (PCB) layout techniques. The AI agent may employ reinforcement learning algorithms. The AI agent may detect electrical issues. The AI agent may provide suggestions for resolving the detected electrical issues. The AI agent may provide guidance for refining the design. The EDA tool may be web-based. The EDA tool may be desktop-based.

According to an aspect of one or more examples, there is provided a non-transitory computer-readable medium encoding instructions that, when executed by one or more processors of a computing device, cause the computing device to perform a method. The method may include receiving, at the computing device, a set of electronic design automation (EDA)-related knowledge data associated with user activity on an EDA tool, processing, at the computing device, the received knowledge data to generate an updated set of electronic design methodologies data, transmitting the updated set of electronic design methodologies data to a cloud-based EDA artificial intelligence (AI) expert module for refinement, receiving, from the cloud-based EDA AI expert module, a new set of refined electronic design methodologies data, storing, at the computing device, the received refined electronic design methodologies data along with historical electronic design methodologies data, analyzing, at the computing device, a user interaction with the EDA tool in relation to the refined electronic design methodologies data, and providing, at the computing device, design assistance to the user based on the analysis.

### BRIEF DESCRIPTION OF DRAWINGS

FIG. 1 shows an electronic design automation (EDA) cloud system architecture using an artificial intelligence (AI) expert system according to one or more examples.

FIG. 2 shows a flowchart of a computer-implemented method for resource sharing in an electronic design automation (EDA) cloud architecture according to one or more examples.

FIG. 3 shows a block diagram of a computing device according to one or more examples.

### DETAILED DESCRIPTION OF VARIOUS EXAMPLES

Reference will now be made in detail to the following various examples, which are illustrated in the accompanying drawings, wherein like reference numerals refer to like elements throughout. The following examples may be exemplified in various forms without being limited to the examples set forth herein.

Electronic Design Automation (EDA) tools have schematic and circuit design functionalities along with manual circuit simulation capabilities. These tools have evolved to incorporate features, such as automatic on-the-fly simulation during schematic modifications and on-the-fly validation while creating schematic diagrams. Moreover, some EDA tools use static artificial intelligence (AI) and machine learning (ML) algorithms to facilitate chip design modeling and simulation processes. Despite the advancements in EDA tools, there persists a challenge in knowledge sharing related to electronic design among multiple users. Therefore, there exists a need for a system and method that may facilitate resource sharing in an EDA cloud architecture.

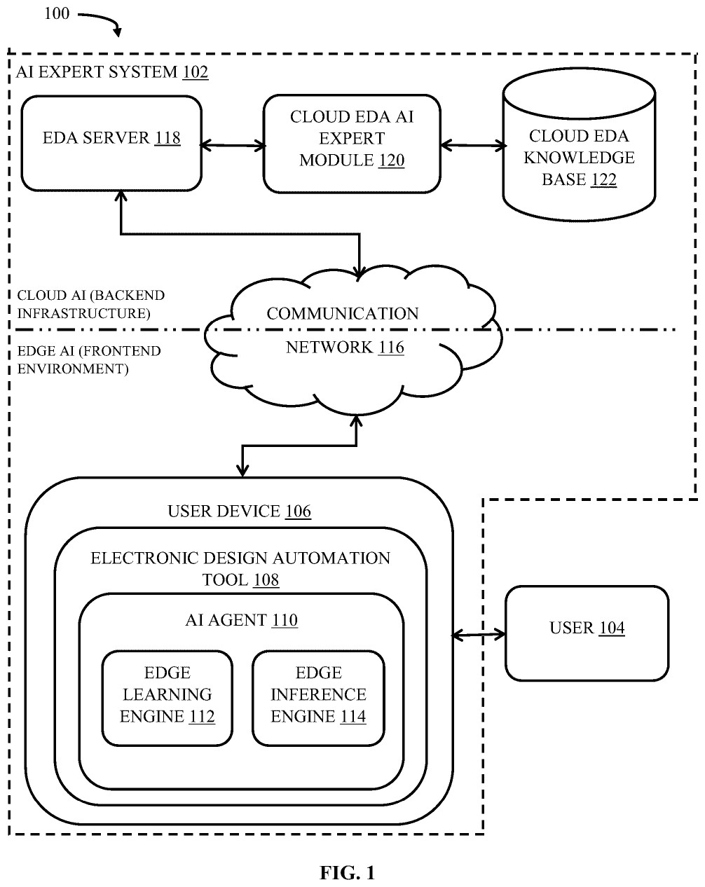

FIG. 1 shows an electronic design automation (EDA) cloud system architecture 100 according to one or more examples. The EDA cloud system architecture 100 may include an artificial intelligence (AI) expert system 102 and a user 104. The EDA cloud system architecture 100 may be any environment which facilitates interaction of the user 104 with the AI expert system 102. The user 104 may be any person or individual who access the AI expert system 102 to perform a designing process. In one or more examples, the user 104 may be an expert electronic computer-aided design (ECAD) user, a senior ECAD user, an intermediate ECAD user, a junior ECAD user, or a novice ECAD user, without limitation.

The EDA cloud system architecture 100 may include the AI expert system 102. The AI expert system 102 may include a cloud AI, which may correspond to a backend infrastructure, and an EDGE AI, which may correspond to a frontend environment. The AI expert system 102 may include a user device 106 in the frontend environment. However, those skilled in the art would appreciate that the AI expert system 102 may include a greater number of user devices. In various examples, the user device 106 may be a portable user device. The portable user device may be a laptop, smartphone, tablet, or smart watch, without limitation. In various examples, the user device 106 may be a fixed user device. The fixed user device may be a desktop, workstation, smart TV, or mainframe computer, without limitation. The user device 106 may be any type of device that has ability to communicate with other devices using an active internet connection.

The AI expert system 102 may include an EDA tool 108 in the frontend environment. The EDA tool 108 may be accessed on the user device 106 by the user 104. In various examples, the EDA tool 108 may be a web-based EDA application. In various examples, the EDA tool 108 may be a desktop-based EDA application.

The EDA cloud AI system 102 may include an AI agent 110 in the frontend environment. The AI agent 110 in the EDA tool 108 may be used by the user 104 using the user device 106. The AI agent 110 may receive a set of EDA related knowledge data associated with a user activity on the EDA tool 108. The AI agent 110 may include a neural network that uses one or more reinforcement learning algorithms to assist the user 104 in the designing process. The AI agent 110 may detect one or more electrical issues in the designing process. The AI agent 110 may provide one or more suggestions to the user 104 to fix the one or more electrical issues during the designing process. The AI agent 110 may provide the one or more suggestions to the user 104 for one or more electrical enhancements during the designing process.

The AI agent 110 may include an edge learning engine 112 that may process the set of EDA related knowledge data to detect a new set of electronic design methodologies data. The new set of electronic design methodologies data may correspond to relevant knowledge in an electronic designing field. Moreover, the AI agent 110 may include an edge inference engine 114 that processes a new set of refined electronic design methodologies data along with a historical set of electronic design methodologies data. The edge inference engine 114 may evaluate a user interaction with the EDA tool 108 and a processed set of electronic design methodologies data. The AI agent 110, by the means of the edge inference engine 114, may assist the user 104 in the designing process based on the evaluation.

The EDA cloud AI system 102 may include a communication network 116. The communication network 116 may provide a medium for the frontend environment to connect with the backend infrastructure. In various examples, the communication network 116 may be an internet connection, a wireless mobile network, a wired network with a finite bandwidth, or a combination of the wireless and the wired network, without limitation. In another example, the communication network 116 may be an optical fiber high bandwidth network that enables a high data rate with negligible connection drops. The communication network 116 may include a set of channels. Each channel of the set of channels may support a finite bandwidth. In addition, the finite bandwidth of each channel of the set of channels may be based on capacity of the communication network 116.

The EDA cloud AI system 102 may include an EDA server 118 in the backend infrastructure. However, those skilled in the art would appreciate that the EDA cloud AI system 102 may include a greater number of EDA servers. The EDA server 118 may learn, generate, store, receive, and transmit electronic data, such as executable instructions for knowledge sharing in the EDA cloud system architecture 100. For example, the EDA server 118 may receive data from the user device 106 based on the user activity and the user interaction. In turn, the EDA server 118 may transmit data (e.g., based on the user activity and the user interaction) to the EDA tool 108 in the frontend environment of the EDA cloud system architecture 100.

The EDA cloud AI system 102 may include a cloud EDA AI expert module 120 that may provide intelligence behind the EDA cloud AI system 102, and a cloud EDA knowledge base 122 that may provide a database storage for the new set of refined electronic design methodologies data accumulated by the EDA cloud AI system 102, in the backend infrastructure. The cloud EDA AI expert module 120 may learn and evolve in the electronic designing field using the new set of electronic design methodologies data detected by the AI agent 110. The cloud EDA AI expert module 120 may include a deep neural network architecture that uses one or more deep learning algorithms to learn and evolve in the electronic designing field. The cloud EDA knowledge base 122 may store the new set of refined electronic design methodologies data. The new set of refined electronic design methodologies data may include a plurality of schematics, a plurality of chip designs, and a plurality of printed circuit board (PCB) layout design techniques. The AI agent 110 may be updated with the new set of refined electronic design methodologies data from the cloud EDA AI expert module 120. The edge learning engine 112 may send the new set of electronic design methodologies data to the cloud EDA AI expert module 120, via EDA server 118, subsequently to be stored in the cloud EDA knowledge base 122. The cloud EDA AI expert module 120 may filter, learn and process the new set of electronic design methodologies data to achieve the new set of refined electronic design methodologies data. The cloud EDA knowledge base 122 may be updated with the new set of refined electronic design methodologies data detected by the cloud EDA AI expert module 120.

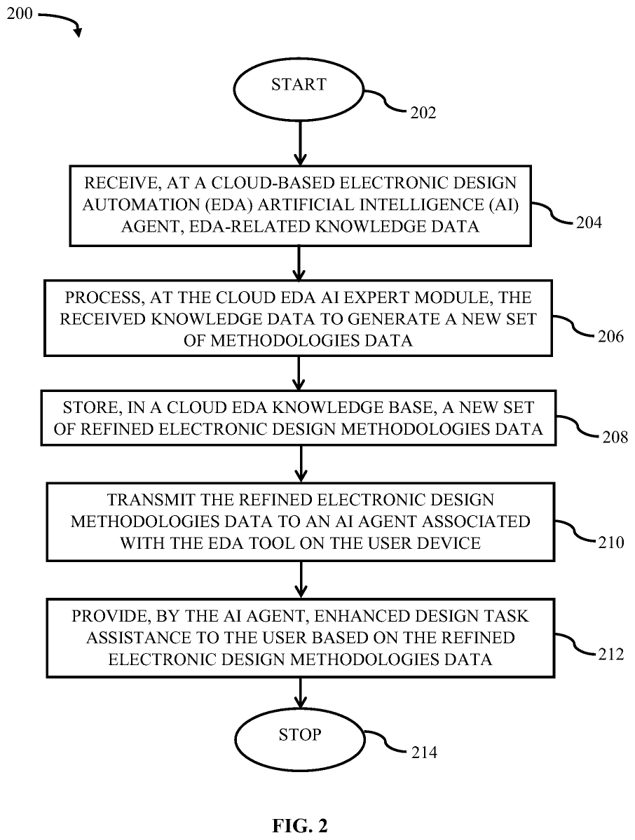

FIG. 2 shows a flowchart of a computer-implemented method 200 for resource sharing in an electronic design automation (EDA) cloud architecture according to one or more examples. The method 200 may start at operation 202. At operation 204, the method 200 may include receiving, at a cloud-based EDA artificial intelligence (AI) expert module, EDA-related knowledge data from a user device, the knowledge data being associated with user activity on an EDA tool. At operation 206, the method 200 may include processing, at the cloud EDA AI expert module, the received knowledge data to generate a new set of methodologies data. At operation 208, the method 200 may include storing, in a cloud EDA knowledge base, a new set of refined electronic methodologies data, wherein the refined data is generated based on aggregated updates and analysis results from the cloud EDA AI expert module. At operation 210, the method 200 may include transmitting the refined electronic design methodologies data to an AI agent associated with the EDA tool on the user device. At operation 212, the method 200 may include providing, by the AI agent, enhanced design task assistance to the user based on the refined electronic design methodologies data received from the cloud EDA AI expert module.

The method 200 may terminate at operation 214. It may be noted that the method 200 is explained to have above stated process operations; however, those skilled in the art would appreciate that the method 200 may have more/less number of process operations which may enable all the above stated examples of the present disclosure.

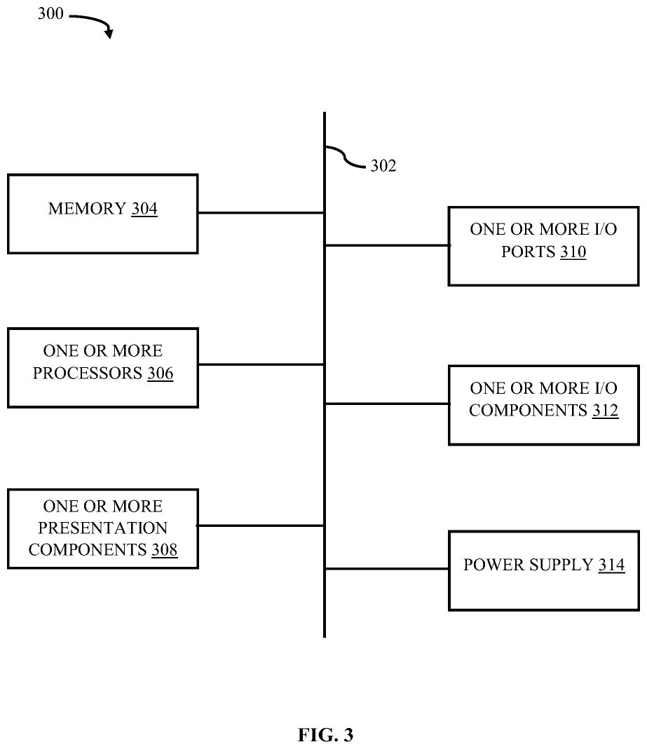

FIG. 3 shows a block diagram of a computing device 300 according to one or more examples that may perform one or more of the processes described above. One will appreciate that one or more computing devices, such as the computing device 300, may represent the computing devices described above (e.g., the user device 106, the EDA server 118). In one or more examples, the computing device 300 may be a mobile device (e.g., a mobile telephone, a smart phone, a PDA, a tablet, a laptop, a camera, a tracker, a watch, a wearable device). In some examples, the computing device 300 may be a non-mobile device (e.g., a desktop computer). Further, the computing device 300 may be a server device that includes cloud-based processing and storage capabilities.

As shown in FIG. 3, the computing device may include a memory 304, one or more processor(s) 306, one or more presentation component(s) 308, one or more I/O port(s) 310, one or more I/O component(s) 312, and a power supply 314, which may be communicatively coupled by way of a bus 302. While the computing device 300 is shown in FIG. 3, the components illustrated in FIG. 3 are not limiting. Additional or alternative components may be used in other examples. Furthermore, in certain examples, the computing device 300 may include fewer components than those shown in FIG. 3.

In various examples, the one or more processor(s) 306 may include hardware for executing instructions, such as those making up a computer program. As an example, to execute instructions, the processor(s) 306 may retrieve or fetch the instructions from an internal register, an internal cache, the memory 304, the I/O component(s) 312, or a storage device, and decode and execute them.

The computing device 300 may include the memory 304, which is coupled to the processor(s) 306. The memory 304 may be used for storing data, metadata, and programs for execution by the processor(s) 306. The memory 304 may include one or more of volatile and non-volatile memories, such as Random-Access Memory (“RAM”), Read-Only Memory (“ROM”), a solid-state disk (“SSD”), Flash, Phase Change Memory (“PCM”), or other types of data storage. The memory 304 may be internal or distributed memory.

The computing device 300 may include the storage device for storing data or instructions. As an example, the storage device may include a non-transitory computer-readable medium. The storage device may include a hard disk drive (“HDD”), flash memory, a Universal Serial Bus (USB) drive, or a combination these or other storage devices.

The computing device 300 may include the one or more presentation component(s) 308 that may present data indications to a user or other device. The one or more presentation component(s) 308 may include a display device, speaker, printing component, vibrating component, without limitation. The one or more I/O ports 310 may allow the computing device 300 to be logically coupled to other devices, including the one or more I/O components 312, some of which may be built in.

Various examples have been disclosed herein, in connection with the above description and the drawings. It will be understood that it would be unduly repetitious to literally describe and illustrate each combination and subcombination of these examples. Accordingly, all examples can be combined in any way or combination, and the present specification, including the drawings, shall be construed to constitute a complete written description of all combinations and subcombinations of these examples herein, and of the manner and process of making and using them, and shall support claims to any such combination or subcombination.

It will be appreciated by persons skilled in the art that the examples described herein are not limited to what has been particularly shown and described herein above. In addition, unless mention was made above to the contrary, it is to be noted that all of the accompanying drawings are not to scale. A variety of modifications and variations are possible in light of the above teachings.

What is claimed is:

1. A cloud-based computer system for electronic design automation (EDA), comprising:
one or more processors; and
a memory storing instructions executable by the one or more processors, wherein the instructions, when executed, cause the system to:
provide a cloud EDA artificial intelligence (AI) expert module to learn and evolve in an electronic designing field using a new set of electronic design methodologies data;
store, in a cloud EDA knowledge base, a new set of refined electronic design methodologies data generated by the cloud EDA AI expert module; and
update an AI agent associated with an EDA tool executed on a user device, wherein the AI agent is to:
receive, from the user device, a set of EDA-related knowledge data associated with a user activity on the EDA tool;
transmit the received data to the cloud EDA AI expert module for processing; and
receive, from the cloud EDA AI expert module, the new set of refined electronic design methodologies data to enhance user assistance in the electronic design process.

2. The cloud-based computer system of claim 1, wherein the cloud EDA AI expert module comprises a deep neural network architecture that uses one or more deep learning algorithms to learn and evolve in the electronic designing field.

3. The cloud-based computer system of claim 1, wherein the new set of refined electronic design methodologies data comprises multiple schematics, chip designs, and printed circuit board (PCB) layout techniques.

4. The cloud-based computer system of claim 1, wherein the AI agent comprises a neural network that applies one or more reinforcement learning algorithms to assist the user in the designing process.

5. The cloud-based computer system of claim 1, wherein the AI agent is to detect electrical issues during the designing process.

6. The cloud-based computer system of claim 5, wherein the AI agent is to provide suggestions to the user to resolve the detected electrical issues.

7. The cloud-based computer system of claim 1, wherein the AI agent is to offer suggestions to the user for electrical improvements during the designing process.

8. The cloud-based computer system of claim 1, wherein the EDA tool is web-based.

9. The cloud-based computer system of claim 1, wherein the EDA tool is desktop-based.

10. A computer-implemented method for resource sharing in an electronic design automation (EDA) cloud architecture, comprising:
receiving, at a cloud-based EDA artificial intelligence (AI) expert module, EDA-related knowledge data from a user device, the knowledge data being associated with user activity on an EDA tool;
processing, at the cloud EDA AI expert module, the received knowledge data to generate a new set of methodologies data;
storing, in a cloud EDA knowledge base, a new set of refined electronic design methodologies data, wherein the refined data is generated based on aggregated updates and analysis results from the cloud EDA AI expert module;
transmitting the refined electronic design methodologies data to an AI agent associated with the EDA tool on the user device; and
providing, by the AI agent, enhanced design task assistance to the user based on the refined electronic design methodologies data received from the cloud EDA AI expert module.

11. The computer-implemented method of claim 10, wherein the cloud EDA AI expert module comprises a deep neural network architecture applying deep learning algorithms.

12. The computer-implemented method of claim 10, wherein the refined electronic design methodologies data comprises schematics, chip designs, and printed circuit board (PCB) layout techniques.

13. The computer-implemented method of claim 10, wherein the AI agent is to employ reinforcement learning algorithms.

14. The computer-implemented method of claim 10, wherein the AI agent is to detect electrical issues.

15. The computer-implemented method of claim 14, wherein the AI agent is to provide suggestions for resolving the detected electrical issues.

16. The computer-implemented method of claim 10, wherein the AI agent is to provide guidance for refining the design.

17. The computer-implemented method of claim 10, wherein the EDA tool is web-based.

18. The computer-implemented method of claim 10, wherein the EDA tool is desktop-based.

19. A non-transitory computer-readable medium storing instructions that, when executed by one or more processors of a computing device, cause the computing device to perform a method comprising:
receiving, at the computing device, a set of electronic design automation (EDA)-related knowledge data associated with user activity on an EDA tool;
processing, at the computing device, the received knowledge data to generate an updated set of electronic design methodologies data;
transmitting the updated set of electronic design methodologies data to a cloud-based EDA artificial intelligence (AI) expert module for refinement;
receiving, from the cloud-based EDA AI expert module, a new set of refined electronic design methodologies data;
storing, at the computing device, the received refined electronic design methodologies data along with historical electronic design methodologies data;
analyzing, at the computing device, a user interaction with the EDA tool in relation to the refined electronic design methodologies data; and
providing, at the computing device, design assistance to the user based on the analysis.
